(19) United States
(12) Patent Application Publication
(10) Pub. No.: US 2022/0356760 A1
(43) Pub. Date: Nov. 10, 2022

(54) HYDRAULIC DOOR DRIVE FOR A LIFTING DOOR, LIFTING DOOR COMPRISING THE HYDRAULIC DOOR DRIVE, AND METHOD FOR OPERATING THE HYDRAULIC DOOR DRIVE

(71) Applicant: Efaflex Inzeniring d.o.o. Ljubljana, Ljubljana (SI)

(72) Inventors: Borut Mocnik, Zabnica (SI); Alen Ljoki, Ljubljana (SI); Andrej Mazej, Vodice (SI)

(21) Appl. No.: 17/640,866

(22) PCT Filed: Nov. 3, 2020
(86) PCT No.: PCT/EP2020/080762

§ 371 Date: Mar. 7, 2022

(30) Foreign Application Priority Data
Nov. 12, 2019 (DE) 10 2019 130 425.3

(51) Int. Cl. E06B 9/68; E06B 9/84; E05F 15/59; F15B 1/04

(52) U.S. Cl. CPC E06B 9/68; E06B 9/84; E05F 15/59; F15B 1/04; E06B 2009/808

(57) ABSTRACT

The present invention relates to a hydraulic door drive for a lifting door (1) that opens, in particular, vertically, comprising at least one hydraulic motor (6), adapted and configured to drive a door curtain (2) or to be at least concomitantly driven by the door curtain (2), at least one hydraulic unit (10) for supplying the hydraulic door drive (5) with pressurized hydraulic fluid (13; 13a), characterized by a pressure accumulator (22), wherein
a) potential energy of the door curtain (2), which is released when the latter is closed, can be stored in the form of pressure energy in the pressure accumulator (22), and/or
b) the pressure accumulator (22) can be loaded with pressure energy by means of the at least one hydraulic unit (10), wherein
c) pressure energy stored in the pressure accumulator (22) can be discharged to the hydraulic motor (6) in order to at least open and/or at least close the door curtain (2).

### BACKGROUND OF THE INVENTION

The present invention relates to a hydraulic door drive for a lifting door according to the preamble of claim 1, a lifting door comprising the hydraulic door drive according to the preamble of claim 15, and a method for operating the hydraulic door drive according to the preamble of claim 18.

A roll-up door having a rollable door curtain is known from US 2016/0369577 A1. This roll-up door is equipped with a position switch. The rollable door curtain is rolled up on a winding shaft above a door opening. The door curtain is driven by means of a drive unit. A hydraulic motor, which is not specified in more detail, is mentioned, among others, as a possible drive unit. A roll-up door of this kind does not have any functions allowing it to be opened and/or closed in an emergency, particularly in the event of a power supply failure.

### SUMMARY OF THE INVENTION

A segmented roll-up door having a drive that may be configured, among others, as a hydraulic drive is known from DE 43 05 007 A1.

A roll-up door which is capable of continuing operation after a power failure is known from EP 0 881 349 A2. For this purpose, backup batteries (rechargeable batteries) are provided in the electric control circuit for the hydraulic system.

A fire protection door which is driven by means of a hydraulic cylinder is known from WO 2006/097843 A1. This door is closed using gravity. In case the door is horizontally displaceable, a hinged counterweight is used which is lifted when the door is opened and is lowered when the door is closed.

A roll-up door suitable for use with emergency tents, field hospitals or the like and operated by a pressurized fluid is known from GB 2520177. A rollable and unrollable door curtain has pressure lines integrated therein that can be folded and flattened. When subjected to a pressurized fluid, whether a liquid or a gas, this door curtain is deployed and unrolled. When pressure is relieved from the lines, the door curtain can be rolled up again by a volute spring. This is thus a self-opening door system that can be closed by means of pressure.

The object of the invention is to provide a hydraulic door drive as well as a lifting door comprising the hydraulic door drive, the service life of which lifting door is extended and in particular the door curtain of which can be opened and closed at high speed.

Furthermore, the hydraulic door drive should be suitable such that emergency closing and/or emergency opening requirements can be fulfilled in a simple manner, in particular in the event of an electric power failure, while avoiding components at risk of fatigue.

Another object of the invention is to provide a suitable method for operating a hydraulic door drive.

This object is attained by a hydraulic door drive having the features of claim 1, a lifting door having the features of claim 15, and a method for operating the hydraulic door drive having the features of claim 18. Advantageous embodiments are provided in the respective sub-claims.

A hydraulic door drive according to the invention, for a lifting door that opens, in particular, vertically, comprises: at least one hydraulic motor, adapted and configured to drive a door curtain or to be at least concomitantly driven by the door curtain, at least one hydraulic unit for supplying the hydraulic door drive with pressurized hydraulic fluid, and a pressure accumulator, wherein
a) potential energy of the door curtain, which is released when the latter is closed, can be stored in the form of pressure energy in the pressure accumulator, and/or
b) the pressure accumulator can be loaded with pressure energy by means of the at least one hydraulic unit,
c) pressure energy stored in the pressure accumulator can be discharged to the hydraulic motor in order to at least open and/or at least close the door curtain.

A hydraulic door drive according to the invention ensures that a lifting door can be quickly opened and/or closed (e.g., lowered), and is also able to reliably operate at least in an emergency operation mode, in particular in the event of a failure of electric power supply.

Furthermore, maintenance is considerably reduced as compared to a mechanical door drive using spring accumulators. Moreover, the risk of injury from breaking springs is prevented.

In addition, the hydraulic door drive according to the invention is suitable in particular for allowing the integration of emergency opening, emergency closing and/or emergency stop devices for the door curtain.

In a preferred embodiment, the hydraulic door drive comprises a pressurized hydraulic fluid that can be fed to the hydraulic motor from a hydraulic unit in order to both open the door curtain and close the door curtain.

It is possible with this embodiment to realize a purely hydraulic door drive, without having to use mechanical energy accumulators, such as, e.g., springs, or any other mechanical, i.e. non-hydraulic, actuators.

According to another embodiment, a first port of the hydraulic motor, which in this operating position acts as a hydraulic fluid outlet, is connected with the pressure accumulator to close the door curtain.

As a result, it is possible to supply pressurized fluid (hydraulic fluid) from the hydraulic motor, which in this case may act as a pump, to the pressure accumulator and to store therein the converted potential energy, e.g. of the door curtain, in the form of pressure energy.

In another embodiment, to open the door curtain, a pressure accumulator and a pressurized fluid supply line of the hydraulic unit are connected with a second port of the hydraulic motor, which in this operating position acts as a hydraulic fluid inlet, and are connected in parallel with each other.

This feature allows a particularly high speed of displacement of the door curtain to be achieved, in particular during descent and ascent of the door curtain. As a result, emergency opening and/or emergency closing functions can be easily realized.

In a preferred embodiment, the hydraulic drive, to secure the door curtain against falling, comprises a linear actuator, in particular a hydraulic linear actuator, capable of interacting with the door curtain so as to lock the latter.

This feature helps to increase safety, particularly in the case of power failure, leakage in the hydraulic door drive, or any other unintended pressure drop, for example in the pressure accumulator.

In another embodiment, the hydraulic motor, to secure the door curtain against falling, is configured as a brake motor with a mechanical brake.

This embodiment provides a mechanical braking device in addition to hydraulic features.

In another embodiment, a line rupture protection valve is provided in an interconnection line between the pressure accumulator and the hydraulic motor to secure the door curtain against falling.

In such a case, leakage of hydraulic fluid can be prevented in the event of an inadvertent leakage or inadvertent pressure drop in a supply line or discharge line of the hydraulic motor.

In another preferred embodiment, the pressure accumulator, to allow the door curtain to be opened or closed in an emergency, is connectable solely with a corresponding supply line of the hydraulic motor, the hydraulic unit not contributing to drive of the hydraulic motor.

With this feature it is possible, despite a failure of electric power supply to the hydraulic unit, to nonetheless ensure an emergency opening and/or emergency closing function based on the stored pressure energy.

In a preferred embodiment, the hydraulic unit is hydraulically coupled to a plurality of hydraulic motors of different door curtains.

The above-mentioned feature can be helpful in simplifying the control of a plurality of door drives.

According to another embodiment, the hydraulic unit is coupled to further driving means such as, e.g., linear actuators of other hydraulic systems.

This feature ensures that the hydraulic unit is suitable for multiple use with different driving means.

In a further preferred embodiment, the pressure accumulator is connected with at least the plurality of hydraulic motors of the hydraulic door drives in the form of a parallel connection.

This feature allows a central pressure energy accumulator to be realized, by means of which different door drives can be supplied via suitable valve means, where appropriate.

According to another embodiment, the hydraulic unit is configured as a linear pump capable of being actuated by a weight, said actuation of the weight being performed by loading an operating ramp.

This feature makes it possible, for example by driving a vehicle, be it a manned or unmanned materials handling vehicle, onto the operating ramp, to supply the hydraulic door drive with energy provided by the weight of the vehicle and to thus ensure that the door can be safely opened/closed even in the event of an electric power failure.

In another preferred embodiment, the hydraulic door drive is arranged within a winding shaft of the door curtain.

This feature allows for a particularly space-saving design. In lifting door constructions in which there is no winding core and in which the door curtain is, for example, guided in spiral guides, it is, in particular, also possible to arrange the hydraulic door drive within the door curtain coil to be wound up while still achieving the same advantages.

In a preferred embodiment, the lifting door is configured as a roll-up door having a rollable door curtain or as a sectional door having door curtain sections that are hingedly displaceable relative to each other.

Furthermore, the object is attained by a lifting door comprising the hydraulic drive according to the invention. Such a lifting door can be expediently configured as a roll-up door or as a sectional door.

According to the invention, the object is attained by a method for operating a hydraulic door drive, in particular using a hydraulic door drive according to the invention, for driving a lifting door that opens, in particular, vertically, comprising at least one hydraulic motor, adapted and configured to drive a door curtain or to be at least concomitantly driven by the door curtain, and comprising at least one hydraulic unit for supplying the hydraulic door drive with pressurized hydraulic fluid.

The method is characterized by providing a pressure accumulator, wherein
a) potential energy of the door curtain, which is released when the latter is closed, can be stored in the form of pressure energy in the pressure accumulator, and/or
b) the pressure accumulator can be loaded with pressure energy by means of the at least one hydraulic unit,
c) pressure energy stored in the pressure accumulator can be discharged to the hydraulic motor in order to at least open the door curtain.

The method according to the invention allows the same advantages to be attained as with the device according to the invention.

In a particular embodiment of the method, pressurized hydraulic fluid is fed from the hydraulic unit to the hydraulic motor to both close the door curtain and open the door curtain. In addition to opening and closing the door curtain, it is thus always possible to provide a sufficient amount of pressure energy in the pressure accumulator.

In order to fill the pressure accumulator with potential energy of the door curtain, it is expedient, according to another advantageous embodiment, to connect a first port of the hydraulic motor, which acts as a hydraulic fluid outlet, with the pressure accumulator.

So that the door curtain can be opened quickly, it is expedient to connect the pressure accumulator with the hydraulic motor for the purpose of discharging pressure energy, with the pressure accumulator and the hydraulic unit being connected in parallel.

In another advantageous embodiment, the pressure accumulator, to open or close the door curtain in an emergency, is connected solely with a corresponding feed line of the hydraulic motor, the hydraulic unit not contributing to drive of the hydraulic motor. This may be particularly useful in the event of an electric power failure. The switching valves required for establishing such a switching state of the system can optionally be moved into the corresponding switching states by means of an emergency power supply device of relatively low capacity or can be suitably set by hand.

In a further advantageous embodiment, a hydraulic cylinder of the hydraulic unit, which is actuated by a weight, is supplied with driving power by loading a drive-on ramp. Such a design of the method according to the invention is expedient, for example, where the lifting door should be operated by materials handling vehicles capable of driving onto the ramp.

Further advantageous embodiments and features/feature combinations will become apparent from the following detailed description.

### BRIEF DESCRIPTION OF THE DRAWINGS

The invention will now be explained in more detail, using examples, by reference to the drawings in which:

FIG. 1 is a greatly schematized perspective view of a lifting door according to the invention which comprises a hydraulic door drive according to the invention;

FIG. 2 is a schematic hydraulic circuit diagram of a first embodiment of the hydraulic door drive according to the invention which is in a “close door” operating position;

FIG. 3 is a schematic hydraulic circuit diagram of a first embodiment of the hydraulic door drive according to the invention which is in an “open door” operating position;

FIG. 4 is a schematic hydraulic circuit diagram of a first embodiment of the hydraulic door drive according to the invention which is in a “release pressure” operating position;

FIG. 5 is a schematic hydraulic circuit diagram of a second embodiment of the hydraulic door drive according to the invention which is in a “hold door” operating position, with a braking motor being provided as a hydraulic motor;

FIG. 6 is a schematic hydraulic circuit diagram of a third embodiment of the hydraulic door drive according to the invention which is in a “hold door” operating position, with a door leaf locking device having a linear actuator/hydraulic cylinder being provided as a fall protection means;

FIG. 7 is a schematic hydraulic circuit diagram of a fourth embodiment of the hydraulic door drive according to the invention which is in a “hold door” operating position, with a line rupture protection valve being provided as a means for securing the door curtain against falling;

FIG. 8 is a hydraulic circuit diagram of a fifth embodiment of the hydraulic door drive according to the invention which additionally comprises an emergency opening/closing means;

FIG. 9 shows an arrangement of a plurality of hydraulic door drives according to the invention;

FIG. 10 shows a sixth embodiment of the hydraulic door drive comprising a hydraulic unit that is driven without electricity.

### DETAILED DESCRIPTION OF EMBODIMENTS OF THE INVENTION

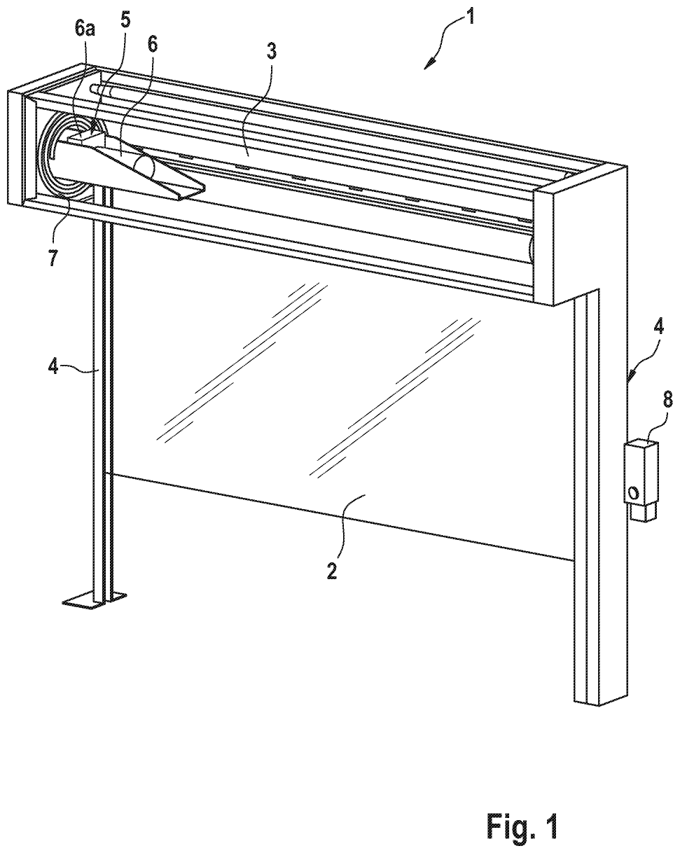

FIG. 1 is a greatly schematized perspective view of a lifting door 1 that can be used for the invention. The lifting door 1 has a rollable door curtain 2 that is guided in vertical guiding tracks 4. In a roll-up box 3 there is provided, as a door drive 5, a hydraulic motor 6 which may interact with the door curtain 2 via a gear mechanism 6a and is capable of rolling the door curtain up and down within the roll-up box 3. The exemplary lifting door 1 is configured without a winding core and has guide spirals 7 in which the door curtain 2 can be rolled up while being guided at its edges. For example, an operating unit 8 is provided in the region of at least one of the vertical guiding tracks 4.

The hydraulic motor 6, and optionally a gear mechanism 6a, are components of the door drive 5 according to the invention which will now be described with reference to the further Figures.

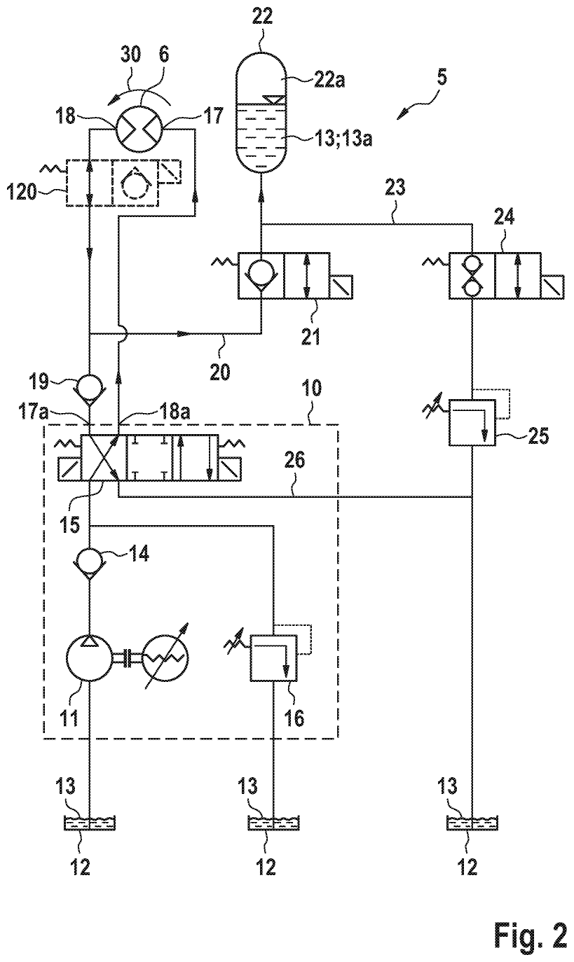

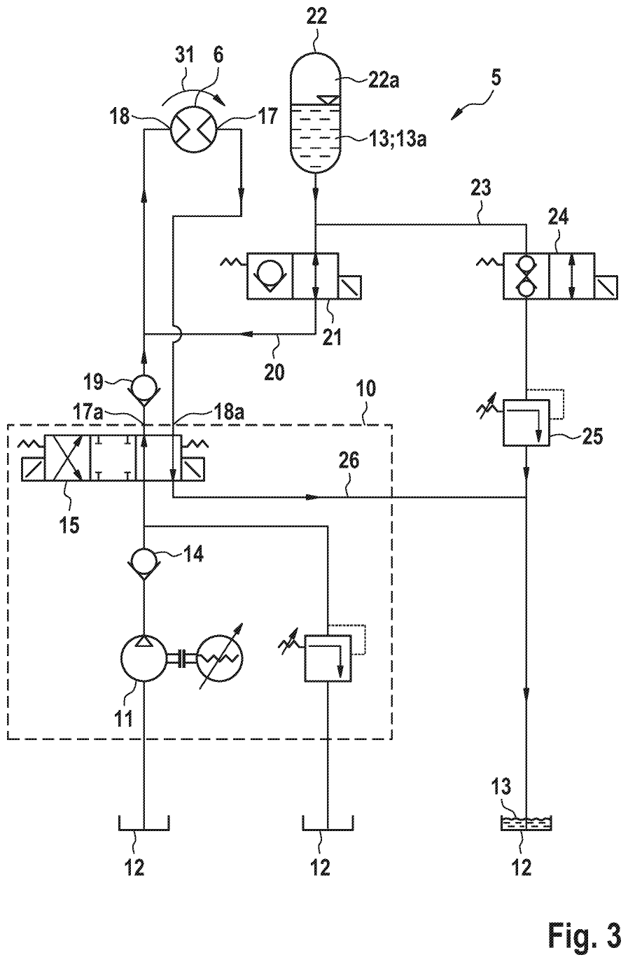

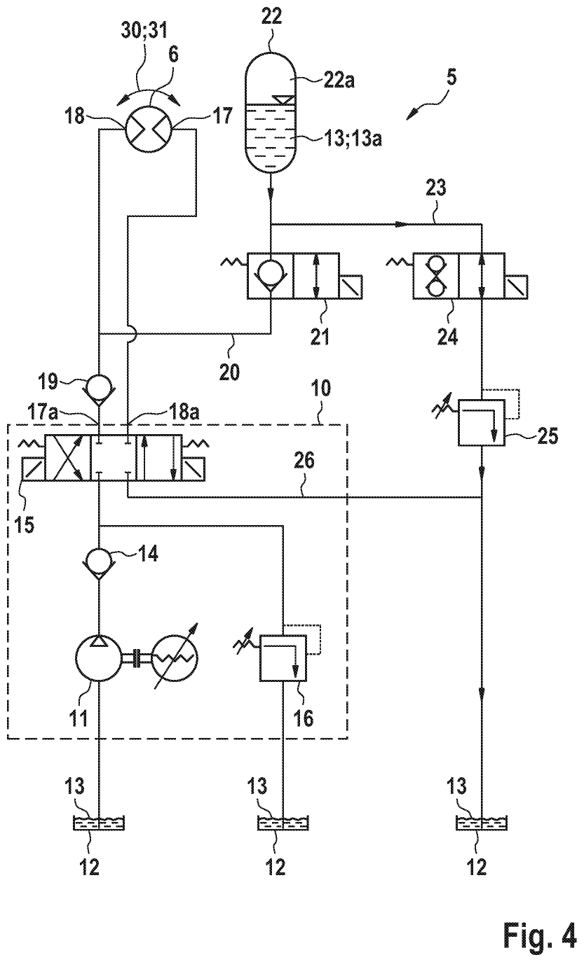

A first embodiment of the hydraulic door drive 5 according to the invention will now be described in different operating positions with reference to FIGS. 2 to 4. A hydraulic circuitry of the first embodiment is identical in terms of the presence and interconnection of hydraulic members and will therefore be described in connection with FIG. 2, whereas only the different operating positions will be discussed in more detail with reference to FIGS. 3 and 4.

The door drive 5 according to the invention comprises a hydraulic unit 10 that is consistently depicted in FIGS. 2 to 9 as a dashed line around individual hydraulic members. The hydraulic unit 10 comprises a hydraulic pump 11 that may receive hydraulic fluid 13 from a hydraulic fluid reservoir (reservoir/tank) 12. The hydraulic pump 11 is driven in a known manner, adjustable in particular in terms of torque and/or speed, by a motor such as, e.g., an electric motor. The hydraulic pump 11 is connected with a first 4/3 directional control valve 15 via a first check valve 14. A line leading back to the reservoir/tank 12 via a first pressure control valve 16 branches off between the first check valve 14 and the first 4/3 directional control valve 15. In the present embodiment, the hydraulic pump 11, the first check valve 14, the first 4/3 directional control valve 15 and the first pressure control valve 16, together with the corresponding connecting lines and connections to the tank(s) 12, thus constitute the hydraulic unit 10.

Outside of the hydraulic unit 10, the hydraulic motor 6 is arranged, for example, in the roll-up box 3 of the lifting door 1 (cf. FIG. 1), as has been explained above. The hydraulic motor 6 comprises a first port 17 and a second port 18. In the switching position of the first 4/3 directional control valve 15 shown in FIG. 2, the first port 17 of the hydraulic motor 6 is connected with a port 18a of the hydraulic unit 10 which acts as a hydraulic fluid outlet (pressure line). The second port 18 of the hydraulic motor 6, which acts as a hydraulic fluid outlet, is connected via a second check valve 19 with a port 17a of the hydraulic unit 10 which acts as a hydraulic fluid inlet. A branch line 20 branches off between the hydraulic motor 6 and the second check valve 19, said branch line 20 being connected with a pressure accumulator 22 via a first 2/2 directional control valve 21 which, in the switching position described in FIG. 2, acts as a check valve. The pressure accumulator 22 may be a gas pressure accumulator having a gas cushion 22a provided therein which can be compressed by means of hydraulic fluid 13, particularly by means of pressurized fluid 13a, i.e. hydraulic fluid under pressure which enters the pressure accumulator 22. By compressing the gas cushion 22a, pressure energy can be stored which will be available for operating the door drive 5 according to the invention, as will be described further below.

A second branch line 23 branches off between the first 2/2 directional control valve 21 and the pressure accumulator 22, said second branch line 23 being connected with a second 2/2 directional control valve 24. The second 2/2 directional control valve is connected on the downstream side with a second pressure control valve 25 which, in turn, discharges on the downstream side into one of the tanks 12 which may also be configured as a common tank/common reservoir. A third branch line 26 branches off between the reservoir/tank 12 and the second pressure control valve 25, said third branch line 26 being connected with the first 4/3 directional control valve 15 and, in the switching position of the first 4/3 directional control valve 15 as shown in FIG. 2, with the second check valve 19.

In the switching position shown in FIG. 2, pressurized fluid 13a flows from the hydraulic pump 11 via the first check valve 14 and the first 4/3 directional control valve 15 to the first port 17 of the hydraulic motor 6 which acts as a hydraulic fluid inlet. The latter is thereby driven in a first direction of drive 30 (e.g. “close door”).

Pressurized fluid 13, which exits the hydraulic motor 6 at the second outlet 18 acting as the hydraulic fluid outlet, enters the pressure accumulator 22 via the first branch line 20 and the first 2/2 directional control valve 21. The second check valve 19 is in a shut-off position, thus preventing reflux into the hydraulic unit 10. It is assumed for the purposes of the present description that, for example, the direction of drive 30 is the “close door” direction of drive, meaning that, as described previously, when the door is being closed, for example lowered, the pressure accumulator 22 is filled with hydraulic fluid 13; 13a with the help of the force of gravity on the door curtain 2, and thus at least the potential energy of the door curtain 2—supplemented, as the case may be, by hydraulic energy of the hydraulic pump 11—is stored. The corresponding aforementioned amounts of energy are, of course, reduced by the corresponding amounts of loss such as, e.g., friction and/or flow resistance.

However, according to the invention, when the door curtain 2 is being closed, e.g. lowered, pressure energy is, as a general rule, accumulated in the pressure accumulator 22. The second branch line 23 has no function in this position since the second 2/2 directional control valve 24 is in a shut-off position. Accordingly, no pressure fluid reaches the second pressure control valve 25 either, and therefore there is no reflux into the tank/reservoir 12 or into the third branch line 26 in this operating position. In its inactive second switching position in FIG. 2, the second 2/2 directional control valve 24 permits “free flow” and serves to relieve pressure from the pressure accumulator 22 if needed. The corresponding pressurized fluid 13a can then be discharged from the pressure accumulator 22 into the tank/reservoir 12 via the second branch line 23, the second 2/2 directional control valve 24 and the second pressure control valve 25.

An essential feature of the invention is the presence of the pressure accumulator 22 which can be fed with hydraulic fluid 13/pressurized fluid 13 resulting from a downward movement of the door curtain 2. In addition to and concurrently with the hydraulic fluid flow described just now, even more pressure can advantageously be built up in the gas cushion 22a of the pressure accumulator 22 by means of the hydraulic unit 10, in particular the hydraulic pump 11.

Operation of the hydraulic door drive in accordance with feature b) of claim 1 is possible with the hydraulic door drive shown in FIG. 2 when using the procedure explained below:

A further 2/2 directional control valve 120, shown as a dashed line in FIG. 2, is provided between the second port 18 and the second check valve 19. When the door is being closed as described above, the further 2/2 directional control valve 120 is in a free flow position as shown in FIG. 2. To load the pressure accumulator 22 with pressure energy from, for example, only the hydraulic unit 10, the further 2/2 directional control valve 120 can be moved into the other switching position as compared to the one shown in FIG. 2, in which it prevents flow of hydraulic fluid (flow of operating fluid) from the port 18 to the check valve 19 or the first 2/2 directional control valve 21. In such a case, the first 4/3 directional control valve 15 is moreover in a switching position as shown in FIG. 3, such that the hydraulic pump 11 is connected with the pressure accumulator 22 via the first 4/3 directional control valve 15, the second check valve 19, the branch line 20 and the first 2/2 directional control valve 21.

In such a switching position, the pressure accumulator 22 can, for example, be loaded with pressure energy by means of the hydraulic unit 10 at times at which it is not to be expected that the door will be actively opened or closed.

This is optionally also possible without movement of the door curtain 2 since in this position the hydraulic motor 6 is not exposed to working fluid.

FIG. 3 shows the first embodiment of the inventive hydraulic door drive according to FIG. 2 in an “open door” operating position. The reference numbers as introduced in FIG. 1 will be retained throughout the description since there is no difference between the hydraulic members. Only the operating positions thereof are different and will be described.

In the operating position shown in FIG. 3, the hydraulic pump 11 is connected via the first check valve 14 with the port 17a, which in this operating position acts as a hydraulic fluid outlet, and with the second check valve 19. From the second check valve 19, the hydraulic fluid 13 or pressurized fluid 13a then passes on to the second port 18 of the hydraulic motor 6 which in this operating position acts as a hydraulic fluid inlet. In this operating position, the first 2/2 directional control valve 21 permits “free flow”, and therefore pressurized fluid 13a from the pressure accumulator 22 also passes to the hydraulic motor 6 via the branch line 20. Thus, the hydraulic motor 6 is supplied with pressurized fluid 13; 13a from both the hydraulic pump 11 and the pressure accumulator 22 for the purpose of opening the door. No pressurized fluid 13a flows in the second branch line 23, since the second 2/2 directional control valve 24 is in the shut-off position. The second pressure control valve 25 also has no function here. The first port 17 of the hydraulic motor 6, which in this operating position acts as a hydraulic fluid outlet, is connected with the port 18a, which in this operating position acts as a hydraulic fluid inlet of the hydraulic unit 10, and is also connected with the third branch line 26, which leads into the tank/reservoir 12, via the first 4/3 directional control valve 15.

It becomes clear from this arrangement that pressure energy stored in the pressure accumulator 22 for door opening purposes assists in driving the hydraulic motor 6 in the second direction of drive 31 which is a direction for opening the door curtain. This helps save driving power for the hydraulic pump 11. Moreover, the existence of a pressure supply in the pressure accumulator 22 allows an increased amount, that is to say an increased volume flow, of the pressure medium 13a to be made available, thus ensuring that the door can be opened at a particularly fast rate.

Unlike FIGS. 2 and 3, FIG. 4 shows a maintenance position of the first embodiment of the door drive according to the invention in which pressure can be relieved from the pressure accumulator 22 in order, for example, to allow maintenance. To this end, the first 2/2 directional control valve 21 is in the switching position in which the check valve 14 of the first 2/2 directional control valve 21 is active and prevents pressurized fluid 13a from flowing from the pressure accumulator 22 into the branch line 20. Moreover, the second 2/2 directional control valve 24 is in a “free flow” switching position so as to allow pressurized fluid 13a from the pressure accumulator 22 to enter the tank/reservoir 12 via the second 2/2 directional control valve 24 and the second pressure control valve 25. The remaining components of the hydraulic door drive according to the invention have no function here.

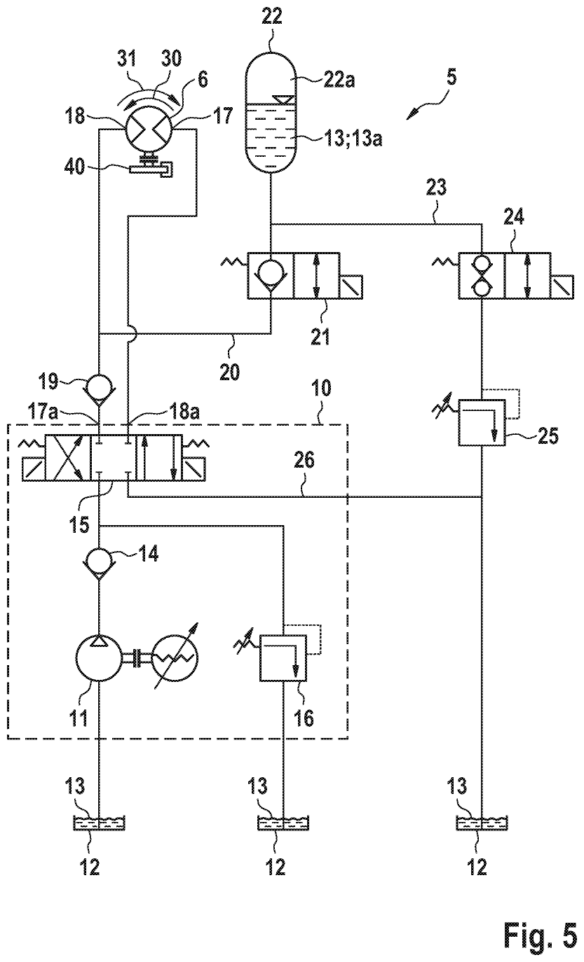

FIG. 5 shows a second embodiment of the door drive 5 according to the invention in a modified form compared to the first embodiment described with reference to FIGS. 2 to 4. Apart from the type of the hydraulic motor 6, which in the present example is configured as a brake motor having an additional mechanical brake 40, the remaining structure of the hydraulic door drive 5 is identical to the first embodiment shown in FIGS. 2 to 4.

Furthermore, the embodiment according to FIG. 5 is shown in an operating position for “holding the door curtain”. To this end, the first 4/3 directional control valve 15 is in a switching position in which the port 17a and the port 18a of the hydraulic unit 10 are blocked. Furthermore, the first 2/2 directional control valve 21 is in a switching position which corresponds to FIG. 2, and therefore pressurized fluid 13a is only allowed to flow into the pressure accumulator 22 and not, however, from the pressure accumulator 22 to the hydraulic motor 6.

Flow of hydraulic fluid through the hydraulic motor 6 is thus blocked. The hydraulic motor 6 stands still and holds the door curtain 2 at rest. In addition to providing the hydraulic blockage described above, this embodiment allows the mechanical brake 40, such as a friction brake, to be activated in relation to the motor, which makes sure that the drive system is mechanically held in place, thus helping to reduce any high compressive loads in the hydraulic circuit.

The mechanical brake 40 of the brake motor thus helps by mechanical ways and means to keep the door curtain 2 at a given position.

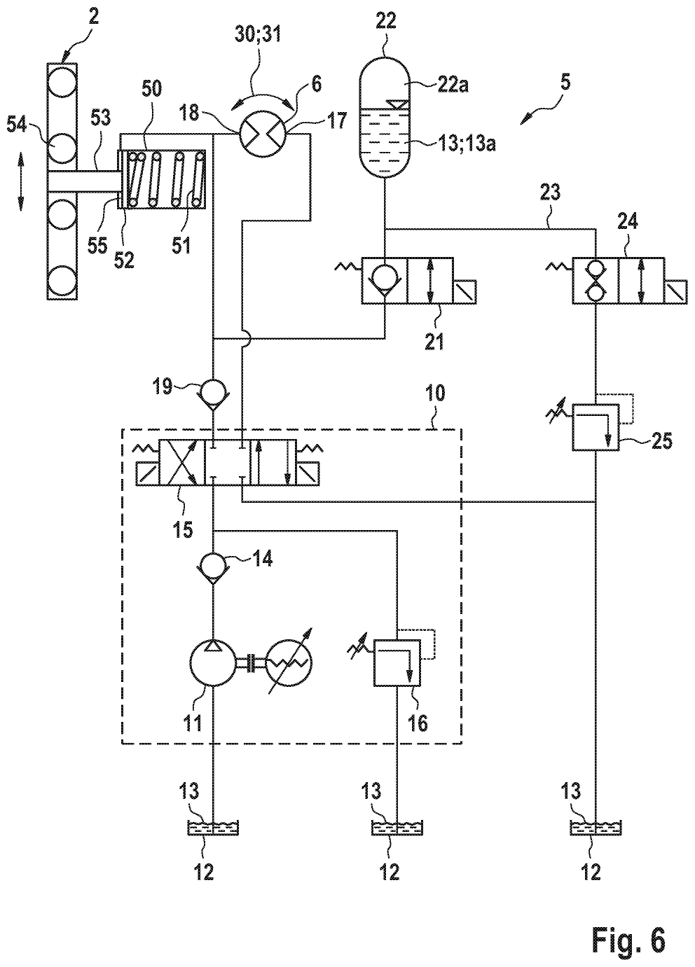

A third embodiment of the door drive 5 according to the invention as shown in FIG. 6 serves the same purpose. Apart from the differences set forth hereinbelow, the hydraulic door drive 5 corresponds, in terms of its hydraulic members, to the embodiment shown in FIGS. 2 to 4. As regards its operating state, the hydraulic door drive 5 according to the third embodiment (FIG. 6) is also in the “hold door curtain” position in which flow of pressurized fluid 13a through the hydraulic motor 6 is suppressed by means of the first 4/3 directional control valve 15.

In a modification of the first embodiment which is shown in FIGS. 2 and 4, the third embodiment according to FIG. 6 additionally comprises a linear actuator 50 which is hydraulically connected in parallel with the second port 18 of the hydraulic motor 6 and is thus also connected with the second check valve 19. The first linear actuator 50 is configured as a hydraulic cylinder and has a piston 52 which is prestressed by a spring 51. The piston 52 is connected with a piston rod 53 which is capable of engaging blocking recesses 54 of the door curtain 2, thus causing the door curtain 2 to be mechanically locked in the upward and downward directions. If the door curtain 2 should be driven, that is to say opened or closed, by means of the hydraulic motor 6, pressurized fluid 13a enters a pressure chamber 55 of the hydraulic cylinder 50 and ensures movement of the piston 52 within the hydraulic cylinder 50 such that the spring 51 is prestressed. This disengages the piston rod 53 from the blocking recesses 54 and releases the door curtain 2 in the upward and downward directions. A spring rate of the spring 51 is adequately selected so that the door curtain 2 is completely unlocked before the hydraulic motor 6 receives sufficient pressure to move the door curtain.

The remaining hydraulic members are identical to the embodiment shown in FIGS. 2 to 4 and also have the same functions. Their description will not be repeated here and their reference numbers will be retained.

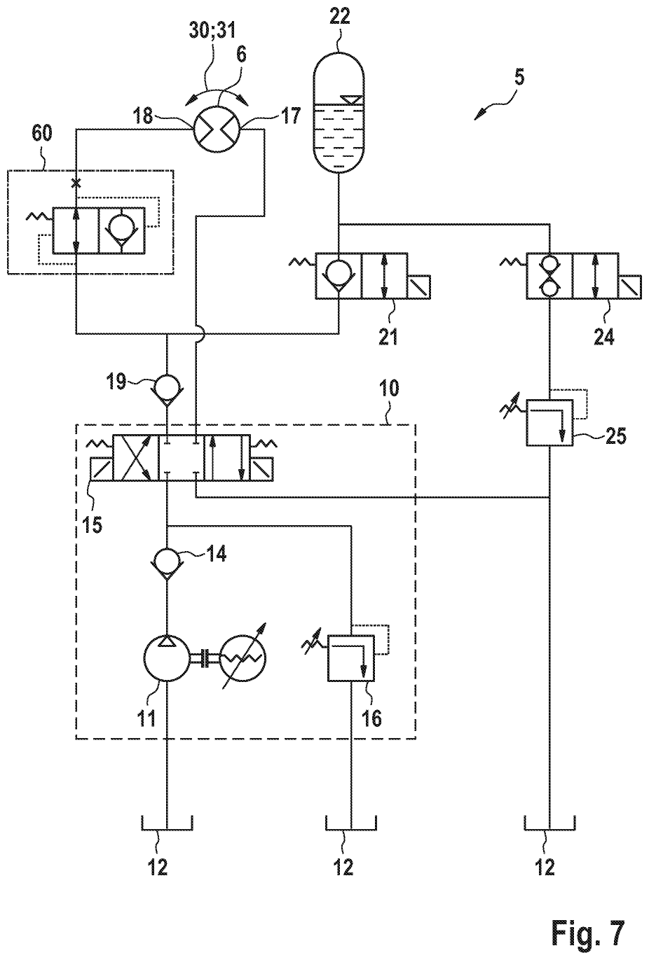

A fourth embodiment of the door drive 5 according to the invention, which, just like embodiments 2 and 3, comprises an additional feature that is designed to fix/block the door curtain 2, i.e. has a “hold door” function, is shown in FIG. 7. As opposed to the embodiments two and three, which, apart from the hydraulic blocking means already provided by the door drive 5, provide an additional blockage which may be driven either electrically, mechanically or hydraulically, the fourth embodiment as shown in FIG. 7 provides an additional hydraulic means for securing the “hold door” function. For this purpose, a line rupture protection valve 60 is provided in the line from the second port 18 of the hydraulic motor 6 to the second check valve 19, said line rupture protection valve 60 permitting free flow when in a position at rest and moving to a shut-off position when there is a pressure drop in one of the lines connected to the line rupture protection valve 60. In the event of a line rupture, that is to say, a line leakage, the line rupture protection valve 60 moves in a known manner to an activation position in which, in the present embodiment example, a check valve 19 is used to suppress hydraulic flow from the hydraulic motor 6 to the pressure accumulator 22 or the second check valve 19. In the event of a line rupture, unintentional movement of the door curtain 2 in the closing direction can thereby be avoided. As a result, the risk of accidents can be reduced.

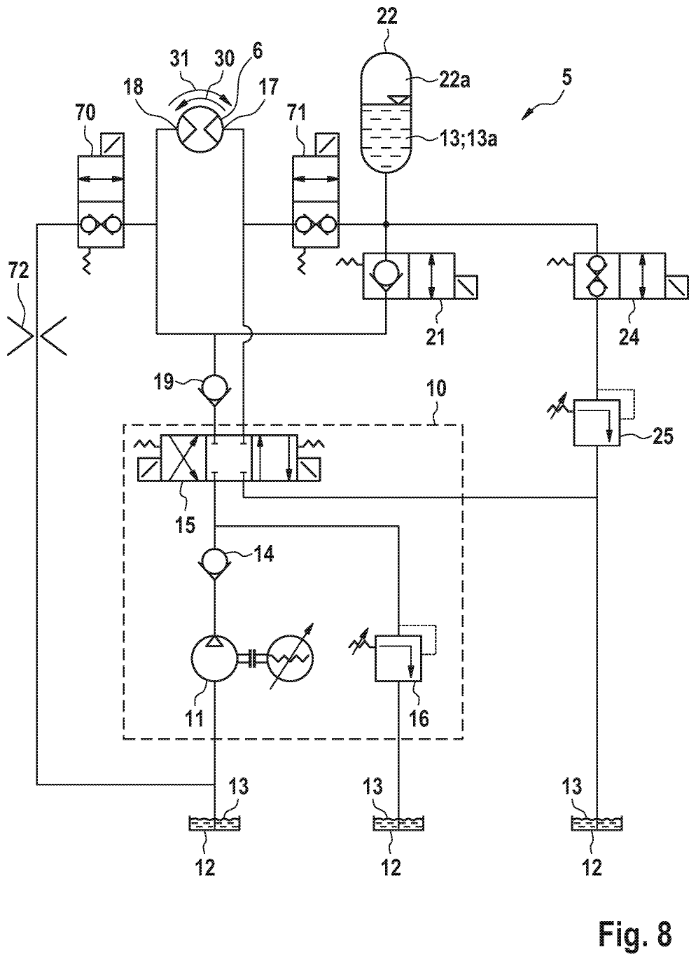

FIG. 8 shows a fifth embodiment of the door drive 5 according to the invention which, in addition to the means of the first embodiment as shown in FIGS. 2 to 4, comprises an emergency opening function which makes the door suitable, for example, for use in escape and rescue routes, and/or an emergency closing function which makes it suitable, for example, for fire protection purposes. This embodiment additionally provides a third 2/2 directional control valve 70 and a fourth 2/2 directional control valve 71 so as to allow both an emergency opening function and an emergency closing function to be realized. The third 2/2 directional control valve 70 has a shut-off position as its normal position and is connected on the one side with the second port 18 of the hydraulic motor 6. On the other side, the third 2/2 directional control valve 70 is connected with the tank/reservoir 12 via a flow reducing means such as an orifice 72 or a throttle.

The fourth 2/2 directional control valve 71 is connected with the first port 17 of the hydraulic motor 6 and has a shut-off position as a normal position. At its other end, the fourth 2/2 directional control valve 71 is connected with the reservoir/tank 12 via the second 2/2 directional control valve 24 and the second pressure control valve 25. It is furthermore connected with the pressure accumulator side of the first 2/2 directional control valve 21.

In a second switching position, which is inactive in the illustration according to FIG. 8, the fourth 2/2 directional control valve 71 permits free flow.

If, for example, the third 2/2 directional control valve 70 and the fourth 2/2 directional control valve 71 are switched so as to permit free flow, pressure can be relieved from the pressure accumulator 22 so that hydraulic fluid or pressurized fluid 13a flows through the hydraulic motor 6 and causes the door curtain 2 to be closed, for example lowered (first direction of drive 30). So that this does not occur more quickly than desired and the door curtain 2 is not abruptly lowered, the orifice 72, which may also be configured as an adjustable orifice and/or adjustable throttle, is provided as a throttling member. This orifice 72 can be used to constrain reflux of the hydraulic fluid 13 so that closing, e.g. lowering, the door becomes possible quickly but within limits (in terms of the lowering speed).

If the third 2/2 directional control valve 70 remains in the shut-off state and only the fourth 2/2 directional control valve 71 is shut off, pressurized fluid 13a is allowed to pass from the pressure accumulator 22 via the first 2/2 directional control valve 21 (which is in the second switching position, i.e. the free flow position that is inactive in FIG. 8) to the second terminal 18 of the hydraulic motor 6, which in this switching position acts as a hydraulic fluid inlet, and to drive the hydraulic motor 6 in the second direction of drive 31, by means of which the door curtain 2 is lifted. So as to allow pressurized fluid 13a to exit the hydraulic motor 6 (via the first port 17), the first 4/3 directional control valve 15 is positioned such that the first port 17 communicates with the tank 12 via the branch line 26. This corresponds to the switching position of the 4/3 directional control valve 15 as shown in FIG. 2. The size of the pressure accumulator 22, as well as the amount of pressurized fluid 13a stored therein under a given pressure, are coordinated in such a way that the pressure energy stored in the pressure accumulator 22 is sufficient to drive the hydraulic motor 6 so that the door curtain 2 can be lifted at least to the extent necessary for it to be opened in an emergency. As a result, the pressure energy stored in the pressure accumulator 22 can be utilized, for example in the event of a power failure, to drive the hydraulic unit 10 to both open the lifting door 1 in an emergency if it is arranged, for example, in an escape route, and close the lifting door 1 in an emergency if it should serve, for example, as an oxygen barrier for firefighting purposes.

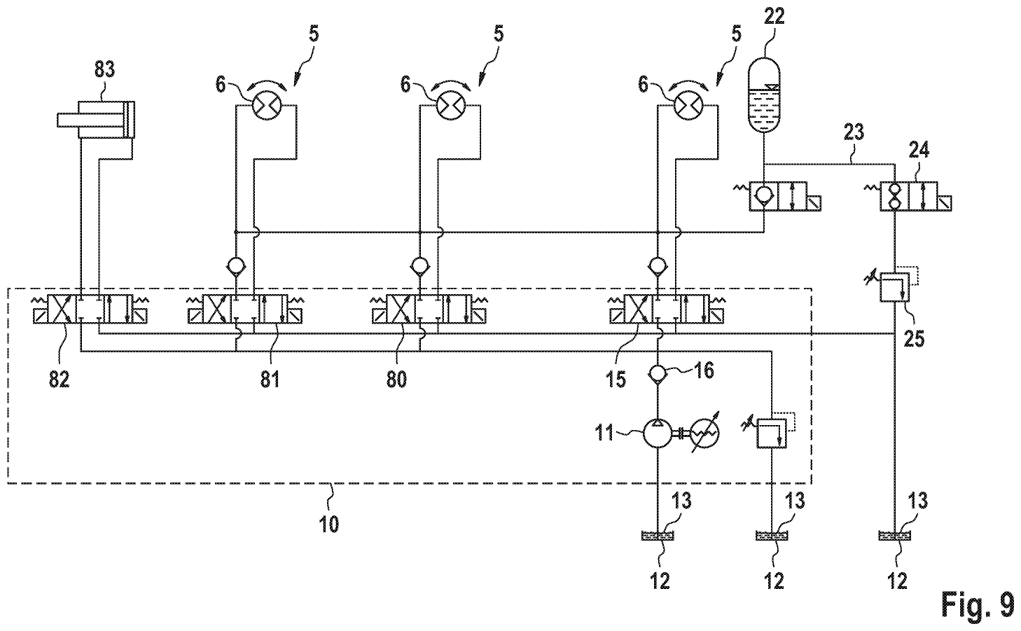

FIG. 9 shows an arrangement of a plurality of hydraulic door drives 5 according to the invention in which a plurality of hydraulic motors 6 are provided. All three door drives 5 are connected with a pressure accumulator 22, as has been explained in more detail in connection with the embodiment in FIG. 1. The hydraulic unit 10 has a second 4/3 directional control valve 80 and a third 4/3 directional control valve 81 which are connected in parallel with the first 4/3 directional control valve 15 and which, as regards their ports, are connected with the hydraulic pump 11 via the first pressure control valve 16, just like the first 4/3 directional control valve 15. Also provided in this example is a fourth 4/3 directional control valve 82 which offers the possibility of supplying a second linear actuator (hydraulic cylinder) 83 with pressurized fluid 13a or hydraulic fluid 13. This embodiment example makes it possible, for example, to operate a plurality of door drives 5 and optionally other hydraulic drives (linear cylinders) by means of a single (multi-channel) hydraulic unit 10, with the plurality of door drives 5 being coupled, in accordance with the invention, with the pressure accumulator 22, as described previously.

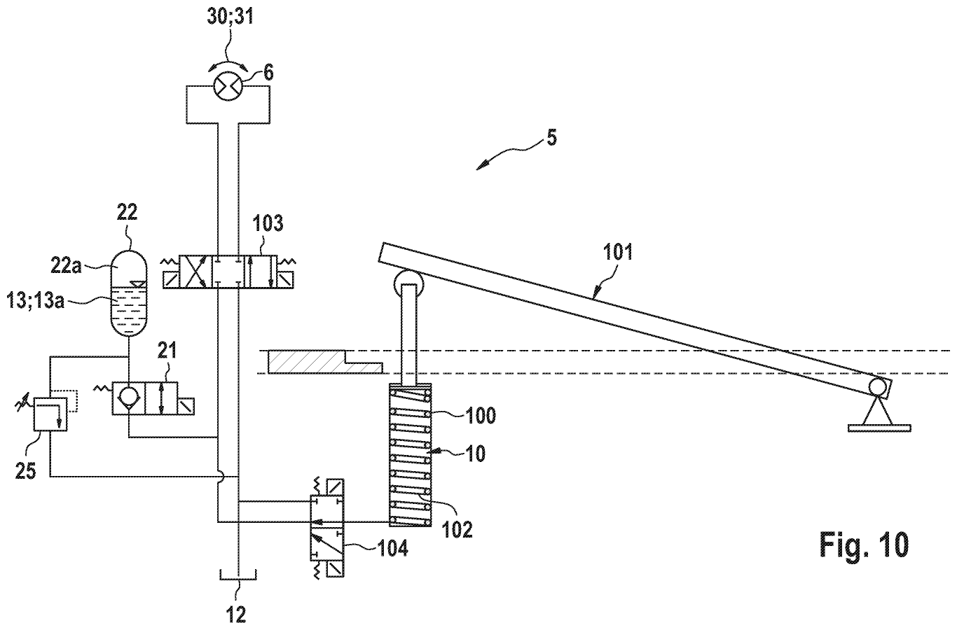

FIG. 10 shows a sixth embodiment of the hydraulic door drive according to the invention, comprising a hydraulic unit that is driven without electricity. The hydraulic unit 10 in this embodiment is configured as a linear cylinder 100 which constitutes a linear hydraulic pump 100. The linear hydraulic pump 100 can be actuated by means of a drive-on ramp 101. The drive-on ramp is, for example, built into the floor of a hall and can be driven on by materials handling vehicles such as, e.g., trucks or unmanned transportation systems. Due to the self-weight of such a materials handling vehicle, the ramp 101 is displaced against a spring pressure from a spring 102 in the workspace in the linear hydraulic pump and thereby produces a volume flow of hydraulic fluid. This pressurized flow can be used to drive the hydraulic motor 6 via a fourth 4/3 directional control valve 103. The fourth 4/3 directional control valve 103 provides respectively one switching position for the first direction of drive 30 and the second direction of drive 31 of the hydraulic motor 6. A return line from the hydraulic motor 6 leads into the tank 12. A line connecting the first 2/2 directional control valve 21 with the pressure accumulator 22 branches off from the pressure line that is connected with the interior of the linear hydraulic pump 100.

The second pressure control valve 25, via which pressurized fluid may return into the tank 12 in the event of overpressure, is connected in parallel therewith, just as in the embodiment example according to FIGS. 2 to 4.

A hydraulic door drive 5 designed in this manner is preferably operated such that when the ramp 101 is being driven on by a materials handling vehicle or is otherwise actuated by a weight, the volume flow thereby produced in the linear pump 101 is fed to the hydraulic motor 6 such that the latter opens the door. As a supporting measure, pressurized hydraulic fluid 13a can be withdrawn from the pressure accumulator 22 by means of the first 2/2 directional control valve 21.

Also provided is a fifth 2/2 directional control valve 104 which, when in the position shown in FIG. 10, corresponds to this operating mode.

In the operating mode “open door” described above, the fourth 4/3 directional control valve 103 is positioned in such a manner, in deviation from that shown in the Figure, that the hydraulic motor 6 opens the door. If the door can be left open, the fourth 4/3 directional control valve 103 is moved into the shut-off position shown in FIG. 10 so that the hydraulic motor 6 is hydraulically blocked. When the door is open like this, materials handling vehicles passing over the ramp 101 can increase the pressure in the pressure accumulator 22 based on the position of the first 2/2 directional control valve shown in FIG. 10, by operating the linear hydraulic pump 100. Such a pressure supply can then be used to open or close the door. In order to be able to repeatedly and consecutively build up pressure in this manner, it may be expedient to provide the linear hydraulic pump 100, in deviation from that shown in FIG. 10, with a hydraulic inlet so as to allow the pump to take in hydraulic fluid from a tank when tension on the spring 102 is released. A check valve may be expedient in this line. As an alternative, such a connection with the tank may be established by the fifth 2/2 directional control valve in the switching position deviating from FIG. 10, in which case it is expedient for the fifth 2/2 directional control valve 104 to remain in the switching position deviating from the one shown in FIG. 10 for as long as hydraulic fluid is taken in.

The above description consistently refers to a rollable door curtain 2 as the door element. However, the entire inventive idea is also readily applicable to a lifting door 1 having an armored door shutter formed of rigid door curtain sections instead of a door curtain 2 within the meaning of web material capable of being rolled up in a flexible and supple manner. To that extent, the term door curtain within the meaning of the present application should also always be understood as meaning an armored door shutter of a sectional door composed of rigid segments or rigid door curtain sections.

The door drive according to the invention makes emergency operation of the door drive possible in a simple manner without requiring mechanical energy storage devices such as, e.g., spring assemblies, and thereby reduces maintenance due to wear and tear associated with energy storage devices of this kind, as well as the risk of accidents.

Furthermore, the door leaf can be secured against falling by very simple hydraulic means and ways, as a result of which costs can be considerably reduced as compared to mechanical actuation systems since oversized brakes and arresting devices can be dispensed with.

Furthermore, by suitably setting the pressure accumulator 22 and the pressure energy stored therein, an unrestricted emergency closing and/or emergency opening function can be made available which allows the door to be opened or closed as appropriate to the situation and independently of the supply of electric power, for example by means of manually operated valves or emergency power supply units such as a battery backup of actuated valves, without requiring electrical energy for the actual driving operation. As a result, fire protection specifications can thus be easily met, particularly as regards the automated provision of escape routes and/or firewalls.

In addition, when an obstacle is detected in the closing path of the door curtain, the door curtain can be easily stopped as quickly as possible and the door opened. A pressure accumulator 22 according to the invention, which stores sufficient amounts of pressure energy, makes it possible to react very quickly to any obstacles detected and to open the door almost instantaneously.

1. A hydraulic door drive for a lifting door (1) that opens, in particular, vertically, comprising
at least one hydraulic motor (6), adapted and configured to drive a door curtain (2) or to be at least concomitantly driven by the door curtain (2);
at least one hydraulic unit (10) for supplying the hydraulic door drive (5) with pressurized hydraulic fluid (13; 13a),
characterized by a pressure accumulator (22), wherein
a) potential energy of the door curtain (2), which is released when the latter is closed, can be stored in the form of pressure energy in the pressure accumulator (22), and/or
b) the pressure accumulator (22) can be loaded with pressure energy by means of the at least one hydraulic unit (10), wherein
c) pressure energy stored in the pressure accumulator (22) can be discharged to the hydraulic motor (6) in order to at least open and/or at least close the door curtain (2).

2. The hydraulic door drive according to claim 1, characterized in that, to both open the door curtain (2) and close the door curtain (2), pressurized hydraulic fluid (13) can be fed from a hydraulic unit (10) to the hydraulic motor (6).

3. The hydraulic door drive according to claim 1, characterized in that, to close the door curtain (2), a first port (17) of the hydraulic motor (6), which acts as a hydraulic fluid outlet, is connected with the pressure accumulator (22).

4. The hydraulic door drive according to claim 1, characterized in that, to open the door curtain (2), the pressure accumulator (22) and a pressurized fluid supply line of the hydraulic unit (10) are connected with a second port (18) of the hydraulic motor (6), which acts as a hydraulic fluid inlet, and are connected in parallel with each other.

5. The hydraulic door drive according to claim 1, characterized in that the hydraulic door drive (5), to secure the door curtain (2) against falling, comprises a linear actuator (50), in particular a hydraulic linear actuator (50), capable of interacting with the door curtain (2) so as to lock the latter.

6. The hydraulic door drive according claim 1, characterized in that the hydraulic motor (6), to secure the door curtain (2) against falling, is configured as a brake motor with a brake (40).

7. The hydraulic door drive according to claim 1, characterized in that, to secure the door curtain (2) against falling, a line rupture protection valve (60) is provided in an interconnection line between the pressure accumulator (22) and the hydraulic motor (6).

8. The hydraulic door drive according to claim 1, characterized in that the pressure accumulator (22), to allow the door curtain (2) to be opened or closed in an emergency, is connectable solely with a corresponding supply line of the hydraulic motor (6), the hydraulic unit (10) not contributing to drive of the hydraulic motor (6).

9. The hydraulic door drive according to claim 1, characterized in that the hydraulic unit (10) is hydraulically coupled to a plurality of hydraulic motors (6) of different door curtains (2).

10. The hydraulic door drive according to claim 1, characterized in that the hydraulic unit (10) is coupled to further driving means such as linear actuators of other hydraulic systems.

11. The hydraulic door drive according to claim 1, characterized in that the pressure accumulator (22) is connected with at least the plurality of hydraulic motors (6) of the hydraulic door drives (5) in the form of a parallel connection.

12. The hydraulic door drive according to claim 1, characterized in that the hydraulic unit (10) is configured as a linear pump capable of being actuated by a weight, said actuation of the weight being performed by loading an operating ramp (101).

13. The hydraulic door drive according to claim 1, characterized in that the hydraulic door drive (5) is arranged within a winding shaft of the door curtain (2).

14. The hydraulic door drive according to claim 1, characterized in that the lifting door (1) is configured as a roll-up door having a rollable door curtain (2) or as a sectional door having door curtain sections that are hingedly displaceable relative to each other.

15. (canceled)

16. (canceled)

17. (canceled)

18. A method for operating a hydraulic door drive (5), in particular using a hydraulic door
drive according to claim 1, for driving a lifting door (1) that opens, in particular, vertically, comprising at least one hydraulic motor (6), adapted and configured to drive a door curtain (2) or to be at least concomitantly driven by the door curtain (2), and comprising at least one hydraulic unit (10) for supplying the hydraulic door drive (5) with pressurized hydraulic fluid, characterized in that a pressure accumulator (22) is provided, wherein
potential energy of the door curtain (2), which is released when the latter is closed, is stored in the form of pressure energy in the pressure accumulator (22), and/or
the pressure accumulator (22) is loaded with pressure energy by means of the at least one hydraulic unit (10),
pressure energy stored in the pressure accumulator (22) is discharged to the hydraulic motor (6) in order to at least open the door curtain (2).

19. The method according to claim 18, characterized in that, to both close the door curtain (2) and open the door curtain (2), pressurized hydraulic fluid (13) is fed from the hydraulic unit (10) to the hydraulic motor (6).

20. The method according to claim 18, characterized in that, to close the door curtain (2), a first port (17) of the hydraulic motor (6), which acts as a hydraulic fluid outlet, is connected with the pressure accumulator (22).

21. The method according to claim 18, characterized in that, to open the door curtain (2), the pressure accumulator (22) is connected with the hydraulic motor (6) for the purpose of discharging pressure energy to the hydraulic motor (6), said connection being such that the pressure accumulator (22) and the hydraulic unit (10) are connected in parallel.

22. The method according to claim 18, characterized in that, to open or close the door curtain (2) in an emergency, the pressure tank (22) is connected solely with a corresponding feed line of the hydraulic motor (6), the hydraulic unit (10) not contributing to drive of the hydraulic motor (6).

23. The method according to claim 18, characterized in that a linear pump of the hydraulic unit (10) capable of being actuated by a weight is supplied with driving power by loading a drive-on ramp (101).
